(19) United States
(12) Patent Application Publication
(10) Pub. No.: US 2013/0226984 A1
(43) Pub. Date: Aug. 29, 2013

(54) METHOD AND APPARATUS OF PROVIDING OPTIMIZED WEB BROWSER COMMUNICATIONS

(71) Applicant: Santhoshkumar Sunderrajan, Goleta, CA (US)

(72) Inventor: Santhoshkumar Sunderrajan, Goleta, CA (US)

(73) Assignee: KASEYA INTERNATIONAL LIMITED, St. Helier (CI)

(21) Appl. No.: 13/405,307

(22) Filed: Feb. 26, 2012

(51) Int. Cl. G06F 15/16

(52) U.S. Cl. 709/202

(57) ABSTRACT

Disclosed are an apparatus and method of establishing a communication session between an administrator and an agent device. The communication session may be setup for the agent to receive a request for information transmitted from the administrator device remotely across a network. The example method may also include processing the request via an embedded web server module of the agent device and creating a response message including the requested information. The agent device may also be configured to transmit the response to the requesting entity or administrator device.

### TECHNICAL FIELD OF THE INVENTION

This invention relates to a method and apparatus of performing optimized browser session communications, and more particularly, to providing an administrator with optimized communication signaling for managing remote agents operating on a communications network.

### BACKGROUND OF THE INVENTION

Asynchronous JavaScript and XML are often combined into a workgroup suite of software development tools referred to as ‘AJAX.’ The term AJAX is often used to refer to a group of interrelated web development methods used on a client-side of a computing environment to create interactive web applications. When using AJAX, web applications can retrieve data from one or more servers asynchronously while operating within the operating system background and without interfering with the display and behavior of the existing user page (web page). Data is usually retrieved using a XML-HTTP-Request object. JavaScript and the XML-HTPP-Request object provide for exchanging data asynchronously between a client side browser and a server without requiring full-page sized data reloads.

A browser extension may be used as a computer program that extends the functionality of a web browser beyond its default capabilities. Modern web browsers used today allow browser extensions through native files and native extensions. The syntax for extensions may be different from browser to browser. When a communication service extension is installed in a browser it may be possible to establish a communication channel relayed through a central server or peer-to-peer type session to a remote system. Browser extensions provide the capability for the native code and Javascript running on a particular web page to interact together without using AJAX related tools. The combination of native code and Javascript together may lead to complicated and proprietary code that is complicated and difficult to utilize.

Conventionally, a transmission control protocol (TCP) server may be implemented on the agent side. This type of configuration requires additional native browser plug-ins to communicate between the browser (Administrator) side and the agent side. There may also be a large amount of communication signaling and a complex corresponding network setup configuration between the administrator side and the agent side to support such a configuration.

### SUMMARY OF THE INVENTION:

An example embodiment of the present invention may include a method establishing a communication session. The method may include receiving a request for information at an agent device and processing the request via an embedded web server module of the agent device and creating a response message including the requested information. The method may include transmitting the response to the requesting entity.

Another example embodiment of the present invention may include an apparatus configured to establish a communication session. The apparatus may include a receiver configured to receive a request for information at an agent device and a processor configured to process the request via an embedded web server module of the agent device and create a response message including the requested information. The apparatus may also include a transmitter configured to transmit the response to the requesting entity.

### BRIEF DESCRIPTION OF THE DRAWINGS

FIG. 1 illustrates a detailed AJAX communication system according to example embodiments of the present invention.

FIG. 2 illustrates an AJAX-based communication network according to example embodiments of the present invention.

FIG. 3 illustrates an example system configured to perform the operations according to one or more example embodiments.

FIG. 4 illustrates an example network entity device configured to store instructions, software, and corresponding hardware for executing the same, according to example embodiments of the present invention.

FIG. 5 illustrates an example method flow diagram, according to example embodiments of the present invention.

### DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of a method, apparatus, and system, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present invention, the invention may be applied to many types of network data, such as, packet, frame, datagram, etc. For purposes of this invention, the term “message” also includes packet, frame, datagram, and any equivalents thereof. Furthermore, while certain types of messages and signaling are depicted in exemplary embodiments of the invention, the invention is not limited to a certain type of message, and the invention is not limited to a certain type of signaling.

Example embodiments of the present invention provide operations and/or procedures used with AJAX technologies to simplify the code on the browser side of a communication network configuration. Even when communicating with a remote system, the remote system may include servers or third party communication data forwarding and/or processing devices that may not be associated with an original web server. For example, a web application may initiate a communication session with multiple servers including those servers that are not public and which are operating on closed networks. The web application may use the same standard AJAX functionality for communication and data exchange purposes. AJAX requests may be sent to a server on the agent side through a communication service established with each of the network entities.

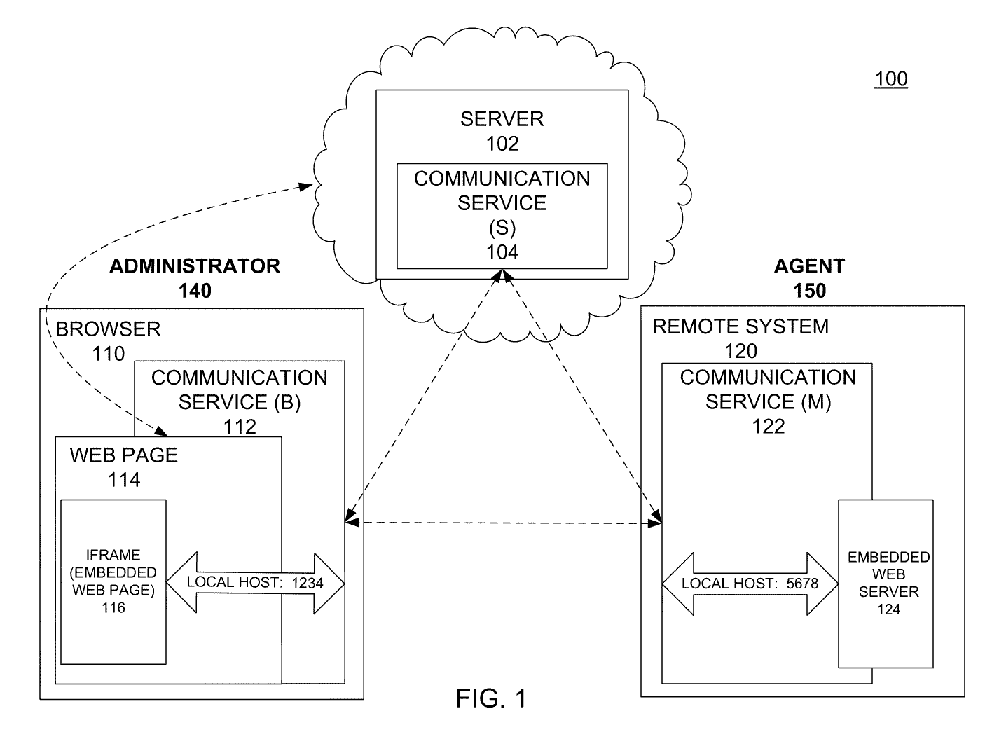

FIG. 1 illustrates an example block diagram communication system according to example embodiments of the present invention. Referring to FIG. 1, a communication network 100 may include a server 102, a user workstation or network node operating a browser 110 and a remote system 120. In operation, a user may login or access a user machine, workstation, or network node (e.g., a computer, laptop, smartphone, tablet computing device, etc.) and initiate a web browser session via the browser 110 to connect with a remote server 102 for any purpose such as downloading a web page. The browser 110 may be operated by an administrator 140 who is accessing a server 102 via a browser 110 to download a web page. The agent 150 may be a remote machine that is managed by the administrator 140. The administrator 140 may operate the browser 110 (e.g., Chrome, Internet Explorer, Firefox, Safari, etc.) to render hypertext transfer markup language (HTML) pages and to support AJAX for establishing a request for data and/or a response from a remote server.

A virtual system administrator (VSA) may be used by contracted service providers to access a remote VSA, which is hosted and maintained by a third party service provider to install a specified number of customer agents. The service providers may be allocated on a unique tenant partition of a shared server and database. Within their assigned partition, service providers can only see their own organizations, machine groups, procedures, reports and tickets. Service providers in a tenant partition have full access to all functions of the VSA except system maintenance, which is the responsibility of a third party service provider. The HTML page of the administrator 140 may be downloaded from the VSA along with its corresponding Javascript. The agent 150 may represent any machine that has the agent application software installed. The agent 150 may be an endpoint on the network that the administrator 140 is configured to monitor, update or support.

Referring to FIG. 1, according to an example method of operation, the browser 110 may initiate a communication session by loading a web page 114 from the server 102. The web page 114 may be requested and retrieved via standard HTTP data communications. The web page 114 uses AJAX to communicate with the server 102 and download web page content without performing page reloads. A communication service is setup and established for creating a secured connection between the web page 114 and the embedded server 124 that might be residing in two different sub-nets behind network address translation (NAT) devices.

During the communication service setup procedure, the web page 114 initiates, loads and begins the communication service (B) browser extension 112. The communication service (B) 112 connects to the public communication service (S) 104, which connects to the remote communication service (M) 122. Communication service (B) 112 and communication service (M) 122 may establish a direct connection (optional). The web page requests are provided to the communication service to setup a communication channel that maps the listening port of the embedded web server on the remote system to a local port on the system running the browser 110. The web page 114 creates an I-FRAME (embedded web page), which is loaded from the embedded web server 124 on the remote system 120 through the new communication channel setup by the communication service. The embedded web page 116 uses AJAX technology to communicate with the embedded web server 124 without page reloads. The embedded web server 124 processes requests, collects data, and responds back with results to the requesting entity (administrator 140). After each web-based request and/or response there are no reloading operations performed for a webpage when rendering the response on the webpage. Once the I-FRAME is loaded from the embedded web page 116, the subsequent requests generated by the administrator 140 and the responses received from the agent 150 will not initiate a page reload for the browser 110, which saves time and processor utilization.

The communication services (B) and (A) may be considered TCP clients that process and communicate messages between the administrative side of a HTML page and the agent side of a HTTP (web) server 102. According to one example operation, assuming the agent is behind a firewall, a HTML page request on the administrative side may not be capable of obtaining a request to the server 102 directly. As a result, the communication service(s)/clients 104, 112, and 122 may be used to deliver commands and responses accordingly to the web page requests and related information request messages received. Communication server 104 (S) may be a server that includes a TCP based relay server that relays messages to the appropriate clients/services. The communication server 104 may be separate from server 102 and/or may be integrated as part of the same server device and/or local computing server group facility.

Operations and communications between the administrator 140 and the agent 150 may provide the administrator 140 with the capability to enter a command in a terminal/shell interface, which may be rendered using HTML. The administrator commands may be entered automatically without human intervention. For every command received via the administrative interface, an AJAX request is sent to the embedded web-server 124 on the agent that executes the received command request and provides the response to the administrator 140 to be rendered on a HTML page. In one example, the administrator 140 would transmit an AJAX request every “T” seconds to retrieve the agent screenshot on the agent machine 150, which would deliver the screen shot to the administrator 140 as a HTTP response.

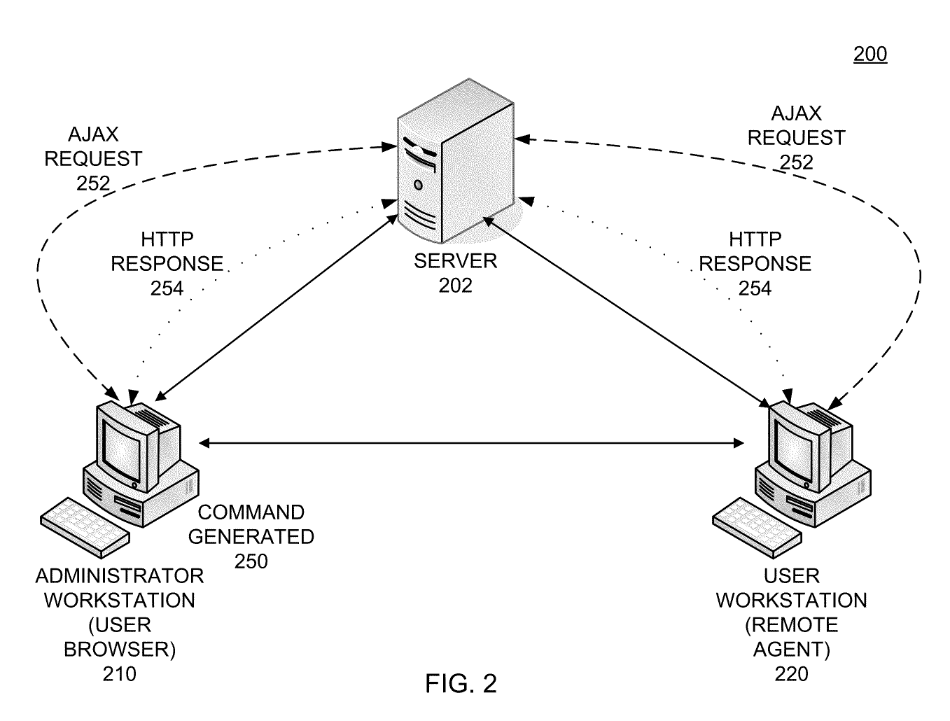

FIG. 2 illustrates an example communication network system configuration according to example embodiments. Referring to FIG. 2, an administrator may be operating as a standalone workstation or server device 210 ‘administrator.’ The administrator 210 may perform transmitting a command 250 via a HTML page to perform a particular operation in association with the agent user workstation 220 ‘agent.’ An AJAX request 252 would be generated that includes the command information and other AJAX specific signaling as part of the AJAX request 252. The request would be forwarded to the server 202, which would forward the AJAX request 252 to the agent 220. In response, the agent 220 would generate and transmit a HTTP response 254. The communication services 112, 104 and 122 (see FIG. 1) would process the communication signaling requests and generate the response messages necessary to answer the request(s). Once the HTTP response 254 to the HTML request is received, the HTML page may render the command output to the administrative workstation 210.

According to another example method of operation, the browser 110 may be considered a network endpoint with a web browser that has an embedded webpage on an I-FRAME 116. The I-FRAME webpage 116 is an inline frame that contains another web page. If a user enters a command on the webpage interface 116, the command will be sent as an AJAX request (HTTP request) to the embedded web server 124. In response, the embedded web server 124 will process the HTTP request and transmit a response. The AJAX request from the I-FRAME webpage 116 is transmitted to the communication service 112, which operates by listening on port localhost: 1234. The communication service 112 will listen and relay data through the communication service 104 (relay server). The communication service 112 may instead relay data through a peer-to-peer connection to the communication service 122. Once the data is received, the communication service 122 may relay the request to the web server listening on the localhost: 5678. A response from the embedded web server 124 is sent back to the I-FRAME embedded web page 116 by passing through the communication service 122 of the agent 150 to the communication service 104 of the web server 102 and to the communication service 112 of the administrator 140.

In operation, the administrator endpoint 140 and the agent endpoint 150 may be located in two separate localities, subnets, etc. As a result, a relay server or peer-to-peer connection may be necessary to establish a communication session between the administrator 140 and the agent 150. The server 102 may be used to relay messages and/or serve web pages to the administrator 140 via the VSA.

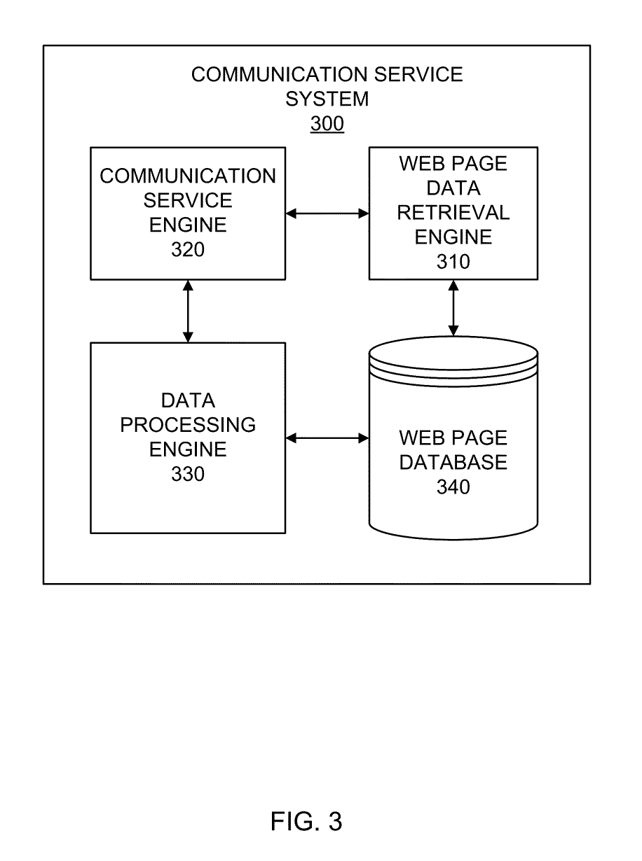

FIG. 3 illustrates an example communication system configuration according to example embodiments. Referring to FIG. 3, the communication service system 300 may include a data retrieval engine 310, a communication service engine 320, a data processing engine 330 and a web page database 340. According to one example method of operation a communication session may be established by receiving a request for information at an agent device, the information may be stored in the web page database 340 at the agent device or at a remote database 340. The example method may also include processing the request via an embedded web server module of a web page data retrieval engine 310 and creating a response message including the requested information via a data processing engine 330. The communication service engine 320 may then transmit the response to the requesting entity (i.e., administrator).

The request received may be an asynchronous JavaScript and extensible markup language (AJAX) type request, and the response message may be a hypertext transfer protocol (HTTP) type response. The requesting device may transmit multiple AJAX requests to the agent device processing system every “T” seconds (i.e., 10 sec, 30 sec, 60 sec., etc.) to retrieve screenshots of present activity conducted on the agent device. The example method may also provide transmitting a plurality of HTTP responses via the communication service engine 320 and a corresponding communication network transmitter to include the screenshots. Once a communication channel is established from the agent device of the requesting entity, a listening port may be mapped from the embedded web server of the agent device to a local port of the requesting entity. In addition, an inline frame (I-FRAME) may be transmitted from the embedded web server of the agent device to the requesting entity. The method further provide loading the I-FRAME on the requesting entity to establish the communication channel and once the I-FRAME is loaded, the subsequent requests received from the requesting entity will not initiate a web page reload operation on the requesting entity.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

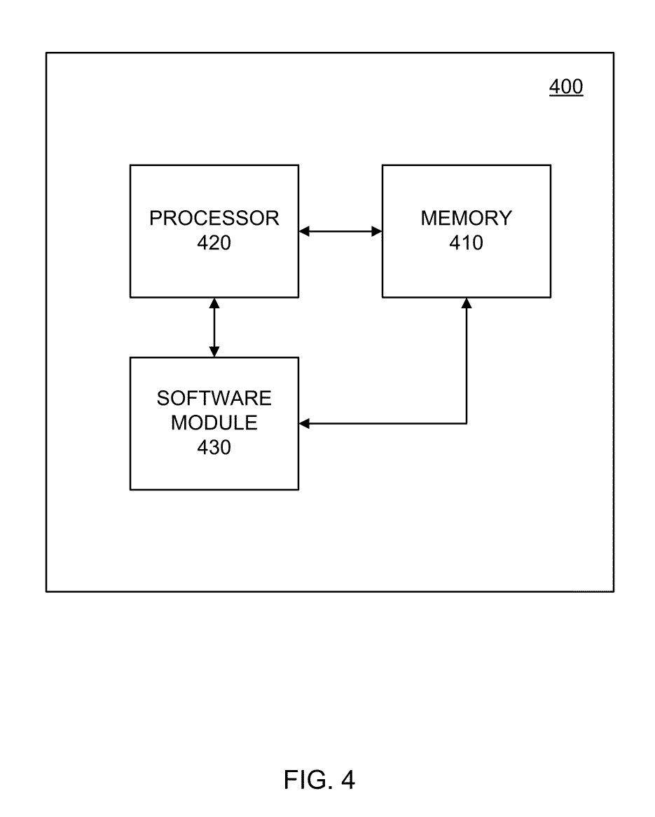

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 4 illustrates an example network element 400, which may represent any of the above-described network components of the other figures.

As illustrated in FIG. 4, a memory 410 and a processor 420 may be discrete components of the network entity 400 that are used to execute an application or set of operations. The application may be coded in software in a computer language understood by the processor 420, and stored in a computer readable medium, such as, the memory 410. The computer readable medium may be a non-transitory computer readable medium that includes tangible hardware components in addition to software stored in memory. Furthermore, a software module 430 may be another discrete entity that is part of the network entity 400, and which contains software instructions that may be executed by the processor 420. In addition to the above noted components of the network entity 400, the network entity 400 may also have a transmitter and receiver pair configured to receive and transmit communication signals (not shown).

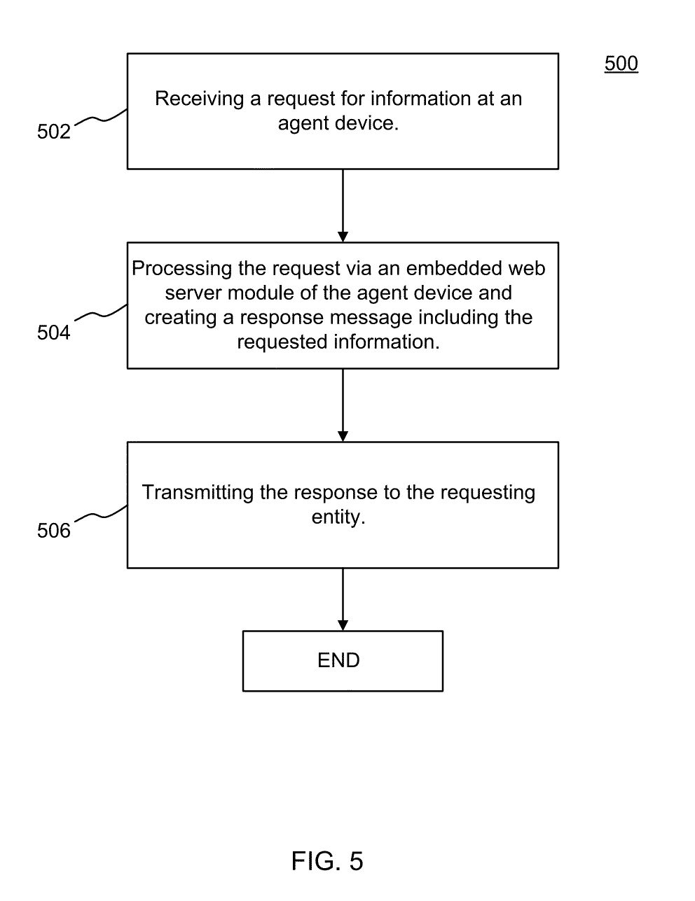

FIG. 5 illustrates one example method of operation according to example embodiments of the present invention. Referring to FIG. 5, a method of establishing a communication session is illustrated in the flow diagram 500. The method may include receiving a request for information at an agent device, at operation 502. The method may also include processing the request via an embedded web server module of the agent device and creating a response message including the requested information, at operation 504 and transmitting the response to the requesting entity at operation 506.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method of establishing a communication session, the method comprising:
receiving a request for information at an agent device;
processing the request via an embedded web server module of the agent device and creating a response message including the requested information; and
transmitting the response to the requesting entity.

2. The method of claim 1, wherein the request is an asynchronous JavaScript and extensible markup language (AJAX) type request.

3. The method of claim 1, wherein the response message is a hypertext transfer protocol (HTTP) type response.

4. The method of claim 2, further comprising:
receiving a plurality of AJAX requests at the agent device every “T” seconds to retrieve screenshots of present activity conducted on the agent device; and
transmitting a plurality of HTTP responses including the screenshots responsive to the receive plurality of AJAX requests.

5. The method of claim 1, further comprising:
establishing a communication channel from the agent device to the requesting entity; and
mapping a listening port of the embedded web server to a local port of the requesting entity.

6. The method of claim 5, further comprising:
transmitting an inline frame (I-FRAME) from the embedded web server of the agent device to the requesting entity; and
loading the I-FRAME on the requesting entity to establish the communication channel.

7. The method of claim 6, wherein once the I-FRAME is loaded, the subsequent requests received from the requesting entity will not initiate a web page reload operation on the requesting entity.

8. An apparatus configured to establish a communication session, the apparatus comprising:
a receiver configured to receive a request for information at an agent device;
a processor configured to process the request via an embedded web server module of the agent device and create a response message including the requested information; and
a transmitter configured to transmit the response to the requesting entity.

9. The apparatus of claim 8, wherein the request is an asynchronous JavaScript and extensible markup language (AJAX) type request.

10. The apparatus of claim 8, wherein the response message is a hypertext transfer protocol (HTTP) type response.

11. The apparatus of claim 9, wherein the receiver is further configured to receive a plurality of AJAX requests at the agent device every “T” seconds to retrieve screenshots of present activity conducted on the agent device, and the transmitter is further configured to transmit a plurality of HTTP responses including the screenshots responsive to the receive plurality of AJAX requests.

12. The apparatus of claim 8, wherein the transmitter is further configured to establish a communication channel from the agent device to the requesting entity, and map a listening port of the embedded web server to a local port of the requesting entity.

13. The apparatus of claim 12, wherein the transmitter is further configured to transmit an inline frame (I-FRAME) from the embedded web server of the agent device to the requesting entity and load the I-FRAME on the requesting entity to establish the communication channel.

14. The apparatus of claim 13, wherein once the I-FRAME is loaded, the subsequent requests received from the requesting entity will not initiate a web page reload operation on the requesting entity.

15. A non-transitory computer readable storage medium configured to store instructions that when executed by a processor perform establishing a communication session, the processor being further configured to perform:
receiving a request for information at an agent device;
processing the request via an embedded web server module of the agent device and creating a response message including the requested information; and
transmitting the response to the requesting entity.

16. The non-transitory computer readable storage medium of claim 15, wherein the request is an asynchronous JavaScript and extensible markup language (AJAX) type request.

17. The non-transitory computer readable storage medium of claim 15, wherein the response message is a hypertext transfer protocol (HTTP) type response.

18. The non-transitory computer readable storage medium of claim 16, wherein the processor is further configured to perform:
receiving a plurality of AJAX requests at the agent device every “T” seconds to retrieve screenshots of present activity conducted on the agent device; and
transmitting a plurality of HTTP responses including the screenshots responsive to the receive plurality of AJAX requests.

19. The non-transitory computer readable storage medium of claim 15, wherein the processor is further configured to perform:
establishing a communication channel from the agent device to the requesting entity; and
mapping a listening port of the embedded web server to a local port of the requesting entity.

20. The non-transitory computer readable storage medium of claim 19, wherein the processor is further configured to perform:
transmitting an inline frame (I-FRAME) from the embedded web server of the agent device to the requesting entity; and
loading the I-FRAME on the requesting entity to establish the communication channel, and wherein once the I-FRAME is loaded, the subsequent requests received from the requesting entity will not initiate a web page reload operation on the requesting entity.
